(19) United States
(12) Patent Application Publication
(10) Pub. No.: US 2010/0064778 A1
(43) Pub. Date: Mar. 18, 2010

(54) TESTING APPARATUS AND METHOD FOR VALVES

(75) Inventor: Russ Simpson, Bradford (CA)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Town of Markham, Markham (CA)

(21) Appl. No.: 12/233,088

(22) Filed: Sep. 18, 2008

(51) Int. Cl. G01M 3/28

(52) U.S. Cl. 73/46

(57) ABSTRACT

The present invention discloses a testing apparatus and a method for testing valves used in municipal water distribution pipeline networks, particularly air-release/vacuum-breaker combination valves. The testing apparatus comprises a cylindrical reservoir to which the valve to be tested is connected. Testing is performed with water at the desired pressure, with compressed air, with vacuum and/or with a combination thereof. A determination as to a test valve's operational state is made based on the presence or absence of gas and liquid discharges and/or suction noises from the outlet, inlet, seals and joints of the valve.

### CROSS REFERENCE TO RELATED APPLICATIONS

This application claims priority to Canadian Patent Application filed Sep. 15, 2008 (for which the application number is currently unknown), entitled Testing Apparatus and Method for Valves, the teachings of which are incorporated herein by reference.

### FIELD OF THE INVENTION

The present invention relates to a testing apparatus and method for evaluating the operation of air-release/vacuum-breaker combination valves, of the type commonly used in municipal water distribution pipeline networks.

### BACKGROUND OF THE INVENTION

Municipal water distribution systems encompass hundreds and thousands of kilometres of underground watermains for a medium to large city. A very important role for maintaining the normal parameters of water delivery within this network of pipes is played by various valves and fittings. An illustrative example from this class is the air-release valve, a type of mechanical device placed on watermains. Air-release valves are designed to open automatically to the atmosphere whenever they detect pockets of air trapped in the watermains, yet are also designed to close automatically after all the air is purged to prevent any significant loss of liquid. Air trapped in the watermains would otherwise cause a series of problems ranging from total blockage of water flow (the so-called “air lock”) to insufficient flow rates (trapped air acts similar to a solid obstruction inside a pipe, effectively reducing the available flow path for water) to complaints from end users due to noisy pipes and sputtering, gurgling or turbulent flow when opening faucets.

Vacuum-breaker valves play an equally important but opposite role on watermains: they open automatically to allow air to be drawn into the water pipe. This is useful when only a portion of a watermain needs to be emptied of water, as the air allowed in by the vacuum-breaker valve will speed up the draining and will prevent the siphoning of water from neighbouring portions of the watermain.

Advances in this field in the past 50+ years have lead to the introduction of the air-release/vacuum-breaker combination valve, a device that combines the two above-mentioned roles into one robust package. Due to their higher original price, these combination valves were installed in the beginning only on the few largest watermains in a given distribution system. As the price of the combination valves went down in time, and as municipalities came to appreciate their importance, the installed base of combination valves has greatly expanded and they are now in widespread use on smaller watermains. A medium to large, modern municipal water distribution system contains hundreds and thousands of such valves, distributed over a large area.

While these valves are generally of a robust construction and can work unattended for years and decades, they are nonetheless subject to corrosion, seizing, clogging and mechanical failure. Moreover, few municipalities were historically aware of the need for regular inspection and maintenance for these valves, and even fewer were willing or able to budget the expense of implementing such a program. This situation is starting to change, and it is estimated that many more municipal waterworks departments across North America have started or intend to implement regular inspection, testing and maintenance programs, covering hundreds of thousands of such combination valves.

Inspecting, testing and performing maintenance on these valves is a difficult and unpleasant task. They are usually located in dark, cramped underground chambers, often under the surface of major streets. The valves are quite large and heavy, as the typical material of construction for the valve body has historically been cast iron. After decades spent underground, many valves display heavy external corrosion. It is exceedingly difficult to perform any valve testing and maintenance in a cramped, dark underground chamber under a busy street. The logical alternative is to install a new or reconditioned valve and take the old valve out.

While the price of new valves has come down in recent years, it is still high enough to warrant not discarding an old valve at the first sign of malfunction. A typical course of action in municipal practice is to discard any valves older than 10 to 20 years and to attempt to repair and recondition newer valves. As a result, it is expected that hundreds of thousands of such valves will likely have to be reconditioned across North America in the near to medium future. It is very expensive to ship such heavy pieces of equipment to any regional valve repair centre and even more expensive to ship them back to manufacturers (most of which are offshore in Asia). As a result, most of the reconditioning and testing of the valves will likely have to be done locally, in the maintenance shop of a municipal waterworks department.

An essential part of the process is the final testing to ensure that the operational capability of the reconditioned valve has been restored to a satisfactory level. We are unaware of any prior art related to any device or method for comprehensive testing of all functional features of a combination valve under stringent parameters that simulate real-world conditions. Currently, the testing is typically done by connecting the valves to a garden hose and filling them with water to check for leaks; this provides no confirmation of proper working for the air-release or vacuum-breaking mechanisms inside the valve.

Even when such a “hose tested” reconditioned valve is further taken out in the field and is installed on “live” watermains (at a significant cost in manpower and time), the only features thus tested are, at best, the absence of leaks and the ability to withstand the system pressure. On a “live” watermain, there are no ready means to test a valve's air-release abilities unless, by a stroke of luck, several air pockets happen to be traveling through that particular watermain at that particular time and in a spot just upstream from the newly installed valve. Furthermore, if no air release was noticed at the outlet of a valve being tested on the live watermain, there would be no ready means to know whether the tested valve did not release due to malfunctioning or due to the fact that no air pockets were present in the watermain at the time to challenge the air-release mechanism.

There is a need for a fast, simple and effective testing apparatus and method to allow full testing of the operational capability of reconditioned combination valves, in the comfort of a maintenance shop, before deploying the valves in the field.

### SUMMARY OF THE INVENTION

The present invention is a simple, portable, inexpensive, comprehensive, easy to operate and effective apparatus and method for testing and evaluating the operational capability, readiness and performance of valves of the type commonly used in municipal water distribution pipeline networks.

The main part of the apparatus is a reservoir. The valve to be tested is connected to a test port on the reservoir, using the same fittings and preferably in the same position and orientation as an actual valve would be installed on a watermain in the field. Water at the desired pressure is then introduced into the reservoir and the test valve is checked for leaks. Repeated small shots of compressed air are then introduced into the reservoir, observing after each burst whether the test valve opens automatically to vent the air and whether, after each air-release, the valve self-closes immediately with minimal loss of liquid. The air and water pressure are then released and the vacuum-breaking test is performed by opening the test valve's drain port. If the test valve does not have a drain port, the reservoir is fitted with its own drain port that can be open to perform the vacuum-breaking test. The sound of air being drawn into the valve, and a strong, steady stream of water draining, are positive signs that the vacuum-breaking mechanism works properly.

In an aspect of the invention, the reservoir is of a cylindrical shape, positioned so that its longitudinal axis is in a generally horizontal orientation, and the test port branches generally vertically upwards from the reservoir and generally perpendicular to the reservoir's longitudinal axis.

In a further aspect of the invention, the reservoir consists of a cylindrical portion of pipe, capped at both ends, the pipe having a diameter between 1″ and 100″, chosen so as to match and simulate the type, construction materials, orientation and diameter of the piping commonly used for feeder mains and distribution mains on the municipal water distribution pipeline networks.

In a particular embodiment of the invention, the test valve is an air-release valve, of the type commonly used in municipal water distribution pipeline networks.

In a further alternative embodiment of the invention, the test valve is a vacuum-breaker valve, of the type commonly used in municipal water distribution pipeline networks.

In a further embodiment of the invention, the test valve is an air-release/vacuum-breaker combination valve, of the type commonly used in municipal water distribution pipeline networks.

In a further embodiment of the invention, the method of testing comprises hydraulic testing of the test valves, using pressurized liquid.

In a further embodiment of the invention, the method of testing comprises pneumatic testing of test valves, using pressurized gas.

In a further embodiment of the invention, the method of testing comprises hydraulic and pneumatic testing of valves, using pressurized liquid and pressurized gas.

In a further embodiment of the invention, the method of testing comprises hydraulic, pneumatic and vacuum testing of valves, using pressurized liquid, pressurized gas and vacuum generated by free-draining a liquid.

Further aspects of the invention will become apparent from the following description.

### BRIEF DESCRIPTION OF THE DRAWINGS

FIG. 1 is a schematic view of the apparatus, with a test valve shown connected to the test port.

FIG. 2 is a photograph of the apparatus, with a test valve shown connected to the test port.

### DETAILED DESCRIPTION OF THE PREFERRED EMBODIMENT

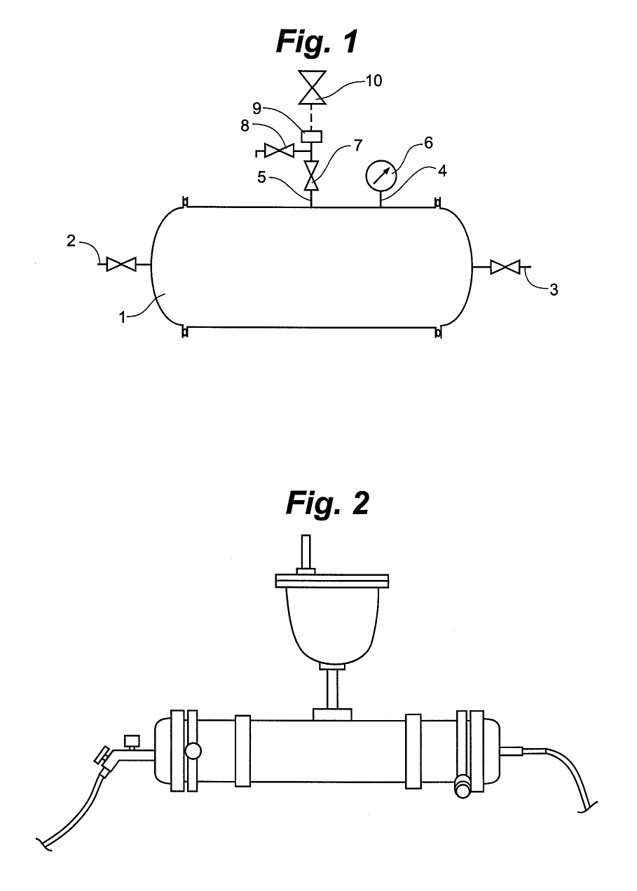

Referring to FIG. 1, the apparatus comprises a reservoir 1, having a hydraulic inlet port with a first isolation valve 2, a pneumatic inlet port with a second isolation valve 3, a pressure measurement port 4, and a test port 5 for receiving a test valve. A pressure gauge is connected to the pressure measurement port 4 and displays the internal pressure in the reservoir. The test port 5 is fitted with a third isolation valve 7, a drain port 8 and a test valve receptacle 9. For the purpose of testing, the test valve 10 is connected to the test valve receptacle 9.

The reservoir 1 is preferably made from a cylindrical section of pipe, capped at both ends. To ensure that the testing apparatus simulates accurately the valve's real-world, field operating conditions, it is preferable that the piping type, construction materials, orientation and diameter of the reservoir are so chosen so as to match and simulate the actual piping type, construction materials, orientation and diameter of feeder mains and/or distribution mains on the municipal water networks on which the tested valve will eventually be installed.

A typical testing methodology includes one or more of the following steps:
a) connecting the test valve 10 to the valve receptacle 9 on the test port 5;
b) connecting a source of pressurized water to the hydraulic inlet port 2, opening the first isolation valve on the hydraulic inlet port and allowing the pressurized water to flow into the reservoir 1 until the desired test pressure is read on the pressure gauge 6;
c) opening the third isolation valve 7 so that the water pressure is equalised between the test valve 10 and the reservoir 1;
d) observing the presence or absence of air and water discharges from the outlet and from the seals and joints of the test valve 10. A properly functioning valve will not leak water through any seals or joints, will release quickly any air with a “whoosh” sound and will shut off by itself with minimal water release. A valve that continuously leaks water from the seals, joints or outlet will be marked as failing the test.
e) connecting a source of compressed air to the pneumatic inlet port 3 and introducing a short burst of compressed air into the reservoir 1 by briefly opening the second isolation valve on the pneumatic inlet port.
f) observing the presence or absence of air and water discharges from the outlet and from the seals and joints of the test valve 10. A properly functioning valve will not leak water through any seals or joints, will release quickly any air with a “whoosh” sound and will shut off by itself with minimal water release. A valve that does not release air or that continuously leaks water from the seals, joints or outlet will be marked as failing the test.
g) shutting off the third isolation valve 7;
h) starting to drain off the water from the test valve 10 by opening the drain port 8 or, if the test valve 10 is equipped with its own drain port, by opening the drain port on the test valve 10;
i) while draining the water from the test valve 10, observing whether air is being drawn into the test valve's outlet. Also observing the flow properties of the stream of liquid draining from the drain port. A noticeable noise of air being drawn in, and a strong, steady stream of water flowing from the drain port, are confirmation that the vacuum-breaking mechanism works properly. If no air sucking noise is detected and the stream of draining water is weak and unsteady, the valve should be marked as failing the test.

1. An apparatus for testing valves, comprising:
a reservoir having a hydraulic inlet port, a pneumatic inlet port, a pressure measurement port, and at least one test port for receiving a test valve;
said pressure measurement port being connected to a pressure measuring means for measuring the internal pressure inside said reservoir;
said hydraulic inlet port having a first isolation valve means;
said pneumatic inlet port having a second isolation valve means;
said test port having a third isolation valve means, a drain port and a valve receptacle for receiving the test valve;
the test valve having one or more inlets and one or more outlets;
a source of pressurized liquid connected to said hydraulic inlet port;
a source of pressurized gas connected to said pneumatic inlet port;
wherein opening said first isolation valve on the hydraulic inlet port causes pressurized liquid to flow into said reservoir;
wherein opening said second isolation valve on the pneumatic inlet port causes pressurized gas to flow into said reservoir;
and wherein connecting the test valve to the test port and opening the third isolation valve on the test port causes the interior space of the reservoir to communicate with the inlet of the test valve.

2. An apparatus for testing valves according to claim 1, wherein the reservoir is of a cylindrical shape, positioned so that its longitudinal axis is in a generally horizontal orientation, and the test port branches generally vertically upwards from the reservoir and generally perpendicular to the reservoir's longitudinal axis.

3-13. (canceled)

14. An apparatus for testing valves according to claim 1, wherein the reservoir consists of a cylindrical portion of pipe, capped at both ends, said pipe having a diameter between 1″ and 100″, chosen so as to match and simulate the type, construction materials, orientation and diameter of the piping commonly used for feeder mains and distribution mains on the municipal water distribution pipeline networks.

15. An apparatus for testing valves according to claim 1 wherein the test valve is an air-release valve, of the type commonly used in municipal water distribution pipeline networks.

16. An apparatus for testing valves according to claim 1, wherein the test valve is a vacuum-breaker valve, of the type commonly used in municipal water distribution pipeline networks.

17. An apparatus for testing valves according to claim 1, wherein the test valve is an air-release/vacuum-breaker combination valve, of the type commonly used in municipal water distribution pipeline networks.

18. An apparatus for testing valves according to claim 2, wherein the reservoir consists of a cylindrical portion of pipe, capped at both ends, said pipe having a diameter between 1″ and 100″, chosen so as to match and simulate the type, construction materials, orientation and diameter of the piping commonly used for feeder mains and distribution mains on the municipal water distribution pipeline networks.

19. An apparatus for testing valves according to claim 2 wherein the test valve is an air-release valve, of the type commonly used in municipal water distribution pipeline networks.

20. An apparatus for testing valves according to claim 2, wherein the test valve is a vacuum-breaker valve, of the type commonly used in municipal water distribution pipeline networks.

21. An apparatus for testing valves according to claim 2, wherein the test valve is an air-release/vacuum-breaker combination valve, of the type commonly used in municipal water distribution pipeline networks.

22. An apparatus for testing valves according to claim 18, wherein the test valve is an air-release valve, of the type commonly used in municipal water distribution pipeline networks.

23. An apparatus for testing valves according to claim 18, wherein the test valve is a vacuum-breaker valve, of the type commonly used in municipal water distribution pipeline networks.

24. An apparatus for testing valves according to claim 18, wherein the test valve is an air-release/vacuum-breaker combination valve, of the type commonly used in municipal water distribution pipeline networks

25. A method of hydraulic testing and gathering information relating to the operational capability, readiness and performance of a test valve, the method comprising the following steps:
i. connecting the inlet of the test valve to a test port on a reservoir, said test port having a third isolation valve interposed between said reservoir and the test valve;
ii. opening the third isolation valve on the test port so as to cause the internal space of the reservoir to communicate with the inlet of the test valve;
iii. causing pressurized liquid to flow into the reservoir and reach the inlet of the test valve;
iv. gathering information relating to the presence or absence of gas and liquid discharges from the outlet, seals and joints of the test valve.

26. A method of testing valves according to claim 25, wherein the test valve is an air-release valve, of the type commonly used in municipal water distribution pipeline networks.

27. A method of testing valves according to claim 25, wherein the test valve is a vacuum-breaker valve, of the type commonly used in municipal water distribution pipeline networks.

28. A method of testing valves according to claim 25, wherein the test valve is an air-release/vacuum-breaker combination valve, of the type commonly used in municipal water distribution pipeline networks.

29. A method of pneumatic testing and gathering information relating to the operational capability, readiness and performance of a test valve, the method comprising the following steps:
i. connecting the inlet of the test valve to the test port on a reservoir, said test port having an isolation valve interposed between said reservoir and the test valve;
ii. opening the isolation valve on the test port so as to cause the internal space of the reservoir to communicate with the inlet of the test valve;
iii. causing pressurized gas to flow into the reservoir and reach the inlet of the test valve;
iv. gathering information relating to the presence or absence of gas and liquid discharges from the outlet, seals and joints of the test valve.

30. A method of testing valves according to claim 29, wherein the test valve is an air-release valve, of the type commonly used in municipal water distribution pipeline networks.

31. A method of testing valves according to claim 29, wherein the test valve is a vacuum-breaker valve, of the type commonly used in municipal water distribution pipeline networks.

32. A method of testing valves according to claim 29, wherein the test valve is an air-release/vacuum-breaker combination valve, of the type commonly used in municipal water distribution pipeline networks.

33. A method of hydraulic and pneumatic testing and gathering information relating to the operational capability readiness and performance of a test valve, the method comprising the following steps:
i. connecting the inlet of the test valve to the test port on a reservoir, said test port having an isolation valve interposed between said reservoir and the test valve;
ii. opening the isolation valve on the test port so as to cause the internal space of the reservoir to communicate with the inlet of the test valve;
iii. causing pressurized liquid to flow into the reservoir and reach the inlet of the test valve;
iv. gathering information relating to the presence or absence of gas and liquid discharges from the outlet, seals and joints of the test valve;
v. further causing pressurized gas to flow into the reservoir and reach the inlet of the test valve;
vi. further gathering information relating to the presence or absence of gas and liquid discharges from the outlet, seals and joints of the test valve.

34. A method of testing valves according to claim 33, wherein the test valve is an air-release valve, of the type commonly used in municipal water distribution pipeline networks.

35. A method of testing valves according to claim 33, wherein the test valve is a vacuum-breaker valve, of the type commonly used in municipal water distribution pipeline networks.

36. A method of testing valves according to claim 33, wherein the test valve is an air-release/vacuum-breaker combination valve, of the type commonly used in municipal water distribution pipeline networks.

37. A method of hydraulic, pneumatic and vacuum testing and gathering information relating to the operational capability readiness and performance of a test valve, the method comprising the following steps:
i. connecting the inlet of the test valve to the test port on a reservoir, said test port having an isolation valve interposed between said reservoir and the test valve;
ii. opening the isolation valve on the test port so as to cause the internal space of the reservoir to communicate with the inlet of the test valve;
iii. causing pressurized liquid to flow into the reservoir and reach the inlet of the test valve;
iv. gathering information relating to the presence or absence of gas and liquid discharges from the outlet, seals and joints of the test valve;
v. further causing pressurized gas to flow into the reservoir and reach the inlet of the test valve;
vi. further gathering information relating to the presence or absence of gas and liquid discharges from the outlet, seals and joints of the test valve;
vii. shutting off the isolation valve on the test port so as to prevent the internal space of the reservoir from communicating with the inlet of the test valve;
viii. draining off the residual liquid from the test valve by opening a drain port on the test port or, if the test valve is equipped with its own drain port, by opening the drain port on the test valve;
ix. while draining the liquid from the test valve, gathering information relating to whether air is being drawn into the test valve through the test valve's outlet and gathering information relating to the flow properties of the stream of liquid draining from the drain port.

38. A method of testing valves according to claim 37, wherein the test valve is an air-release valve, of the type commonly used in municipal water distribution pipeline networks.

39. A method of testing valves according to claim 37, wherein the test valve is a vacuum-breaker valve, of the type commonly used in municipal water distribution pipeline networks.

40. A method of testing valves according to claim 37, wherein the test valve is an air-release/vacuum-breaker combination valve, of the type commonly used in municipal water distribution pipeline networks.
